(19) United States
(12) Patent Application Publication
(10) Pub. No.: US 2025/0326551 A1
(43) Pub. Date: Oct. 23, 2025

(54) RECYCLABLE PACKAGING

(71) Applicant: Sonoco Development, Inc., Hartsville, SC (US)

(72) Inventor: Scott William Huffer, Hartsville, SC (US)

(21) Appl. No.: 18/642,495

(22) Filed: Apr. 22, 2024

(51) Int. Cl. B65D 75/00; B31B 70/26; B32B 7/12; B32B 27/10; B32B 27/32; B32B 27/36; B65D 65/38

(52) U.S. Cl. CPC B65D 75/008; B31B 70/26; B32B 7/12; B32B 27/10; B32B 27/32; B32B 27/36; B65D 65/38; B32B 2255/12; B32B 2255/28; B32B 2307/31; B32B 2307/748; B32B 2439/46; B65D 2207/00; B65D 2565/385

(57) ABSTRACT

A blank is disclosed herein. The blank comprises a paper layer defining a first surface, an opposing second surface, and a longitudinal direction. The blank defines a first fold line dividing the blank into a first half and a second half, a second fold line dividing the first half into a first portion and a second portion, and a third fold line dividing the second half into a third portion and fourth portion. When the first fold line second fold line, and third fold line are folded a triple point is formed between a first region where the first half of the second surface contacts the first fold line and a second region where the second half of the second surface contacts the first fold line. A first adhesive layer is pattern applied in a first pattern. A second adhesive is applied at least partially within the triple point.

### FIELD OF THE DISCLOSURE

The present disclosure relates in general to packaging for products, and more particularly to packaging constructed from recyclable paper-based materials. The invention also comprises methods for manufacturing the recyclable packaging structure.

### BACKGROUND OF THE DISCLOSURE

A variety of food and non-food products are packaged using flexible packaging material formed primarily of one or more polymer films which are inherently heat sealable or are flood coated with a heat sealable material. Likewise, paper-based packaging structures are often also flood coated with a heat sealable material. The packaging structures may, in some cases, then be folded into a pouch or stand-up pouch package and sealed along the various edges thereof. The heat sealable material may therefore be present throughout the interior of the packaging material and may contact the contents of the package and undesirably contaminate the contents thereof (e.g., change the taste). House cats, for example, are often sensitive to the flavor changes which occur when treats or food have been in contact with such heat sealable materials and, in some cases, will not eat such products. As such, there is a need in the art for a packaging structure which can be folded into a pouch or stand-up pouch package without allowing the container contents to contact any adhesive or heat sealable material.

Through ingenuity and hard work, the inventors have developed a blank and corresponding package which prevents contact between the heat seal material or adhesive and the contents of the container.

### BRIEF SUMMARY OF THE DISCLOSURE

In an embodiment, the present invention comprises a paper packaging structure that comprises a pattern applied adhesive with increased adhesive at and around the triple points of the package. The present invention comprises a paper layer and a barrier layer adhesively applied thereto. An adhesive is pattern applied to the barrier layer such that the adhesive is present at the seams but is not present on the interior surface of the container outside of the seams.

In an example embodiment a blank is provided. The blank comprises a paper layer defining a first surface and a second surface opposite the first surface and a longitudinal direction. The blank further comprises a first fold line disposed in the center of the longitudinal direction of the blank forming a first half and a second half of each of the first surface and the second surface. The first fold line is configured to fold the first half of the first surface towards the second half of the first surface. The blank further comprises a second fold line and third fold line, wherein each of the second and third fold lines are equidistance from the first fold line on opposites of the first fold line. The second fold line is configured to fold a first portion of the second surface towards a second portion of the second surface and the third fold line is configured to fold a third portion of the second surface towards a fourth portion of the second surface. When the first fold line, second fold line, and third fold line, are folded a triple point is formed between a first region where the first half of the second surface contacts the first fold line and a second region where the second half of the second surface contacts the first fold line. The blank further comprises a first adhesive layer applied in a first pattern to the second surface. The first pattern defines a first width about a perimeter of the second surface, and includes a first extension and a second extension each defining a second width. The second width extends beyond the first width towards a center of the blank. The blank further includes a second adhesive layer disposed at least partially within the triple point.

In some embodiments, the first extension and the second extension may extend transversely from the first fold line towards and across the second and third fold lines to an end point disposed at a distance which is double the distance from the first fold line to the second or third fold line. In some embodiments, the second width may increase between the first fold line and the end point of the first extension and the second extension. In some embodiments, the second width of the first extension and the second extension may reach a local maximum at a point on the second fold line and a point on the third fold line. In some embodiments, the second width of the first extension and the second extension may reach a local minimum at the center line and at the end point of the first extension and the second extension.

In some embodiments, the second adhesive layer may be disposed at least partially within the first width surrounding a first point which is located a distance which is double the distance from the first fold line to the second fold line and a second point which is located a second distance which is double the distance from the first fold line to the third fold line. In some embodiments, the first point and the second point may be equidistance from the first fold line. In some embodiments, the second adhesive may extend beyond the first width towards the center of the blank.

In some embodiments, the first adhesive layer may comprise a heat sealable material. In some embodiments, the first adhesive layer and the second adhesive layer may comprise the same adhesive. In some embodiments, the blank may further comprise a third adhesive layer. The third adhesive layer may be positioned at least surrounding the first fold line at least within the first width. In some embodiments, the third adhesive may comprise a cold seal adhesive.

In another embodiments a method of making a blank is provided. The method comprises providing a paper layer defining a first surface, a second surface, and a longitudinal direction. The blank further comprises a first fold line disposed in the center of the longitudinal direction of the blank forming a first half and a second half of each of the first surface and the second surface. The first fold line is configured to fold the first half of the first surface towards the second half of the first surface. The blank further comprises a second fold line and third fold line, wherein each of the second and third fold lines are equidistance from the first fold line on opposites of the first fold line. The second fold line is configured to fold a first portion of the second surface towards a second portion of the second surface and the third fold line is configured to fold a third portion of the second surface towards a fourth portion of the second surface. When the first fold line, second fold line, and third fold line, are folded a triple point is formed between a first region where the first half of the second surface contacts the first fold line and a second region where the second half of the second surface contacts the first fold line. The method further comprises applying a first adhesive layer to the second surface of the paper layer in a first pattern. The first pattern defines a first width about a perimeter of the second surface and includes a first extension and a second extension each defining a second width. The second width extends beyond the first width towards a center of the blank. The method further comprises applying a second adhesive layer to the second surface at least partially within the triple point.

In some embodiments, the method further comprises applying a third adhesive layer at least partially surrounding the first fold line at least partially within the first width. In some embodiments, the third adhesive layer may comprise a cold seal adhesive. In some embodiments, the first adhesive layer and the second adhesive layer may comprise a heat sealable adhesive.

In some embodiments, the first extension and the second extension may extend transversely from the first fold line towards and across the second and third fold lines respectively to an end point disposed at a distance which is double the distance from the first fold line to the second or third fold line respectively. In some embodiments, the second width may increase between the first fold line and the end point of the first extension and the second extension respectively.

In some embodiments, a packaging structure may be made from the blank.

In another example embodiment a stand-up pouch is provided. The stand-up pouch may comprise a front wall joined to a rear wall along a top seam, a first side seam, and a second side seam. The pouch further comprises a gusset panel joining the front wall to the rear wall to form a stand-up base of the pouch. The gusset panel is continuous with the front wall and the rear wall. The gusset panel comprises a first triple point disposed within the juncture of the base and first side seal and a second triple point within the juncture of the base and the second side seam. The stand-up pouch further comprises a first adhesive layer applied within each of the first side seam, the second side seam, and the top seam. The stand-up pouch further comprises a second adhesive layer applied within the first triple point and the second triple point.

In some embodiments, the stand-up pouch may further comprise a third adhesive layer positioned about the first triple point and the second triple point. The third adhesive layer may comprise a different adhesive than the first adhesive layer and the second adhesive layer.

In yet another example embodiment a blank is provided. The blank comprises a paper layer defining a first surface and a second surface opposite the first surface and a longitudinal direction. The blank further comprises a first fold line disposed in the center of the longitudinal direction of the blank forming a first half and a second half of each of the first surface and the second surface. The first fold line is configured to fold the first half of the first surface towards the second half of the first surface. The blank further comprises a second fold line and a third fold line, each equidistance from the first fold line on opposite sides of the first fold line. The second fold line is configured to fold a first portion of the second surface towards a second portion of the second surface, and the third fold line is configured to fold a third portion of the second surface towards a fourth portion of the second surface. When the second fold line and the third fold line are folded towards the first fold line a triple point is formed between a first region where the first half of the second surface contacts the first fold line and a second region where the second half of the second surface contacts the first fold line. The blank further comprises a first adhesive layer applied in a first pattern defining a first width about a perimeter of the second surface to the second surface. The blank further comprises a second adhesive layer disposed at least partially within the triple point.

In yet another example embodiment a recyclable package is provided. The recyclable package comprises a recyclable sheet joined along a first end seal, a second end seal, and a lap seal extending between the first end seal and the second end seal. The recyclable package further comprises a first triple point formed at a juncture of the first end seal and the lap seal, and a second triple point is formed at a juncture of the second end seal and the lap seal. The recyclable package further comprises a first adhesive layer applied within each of the first end seal, the second end seal and the lap seal. The recyclable package further comprises a second adhesive layer applied within the first triple point and the second triple point.

### BRIEF DESCRIPTIONS OF THE SEVERAL VIEWS OF THE DRAWING(S)

A full and enabling disclosure directed to one of ordinary skill in the art, is set forth in the specification, which makes reference to the appended drawings, in which:

FIG. 1 illustrates a cross-sectional view of an example packaging structure, in accordance with some embodiments discussed herein;

FIGS. 2A-B illustrate top views of an example blank, in accordance with some embodiments discussed herein;

FIGS. 3A-D illustrate a top view of the example blank and the first adhesive application, in accordance with some embodiments discussed herein;

FIGS. 4A-C illustrate a top view of the example blank with a second adhesive application, in accordance with some embodiments discussed herein;

FIG. 5 illustrates a top view of the example blank with a third adhesive application, in accordance with some embodiments discussed herein;

FIGS. 6A-C illustrate cross-sectional views of the side seam of the blank, folded into an example gusset, in accordance with some embodiments discussed herein;

FIG. 7A illustrates an example stand up pouch, in accordance with some embodiments discussed herein;

FIG. 7B illustrates a top view of the interior of the example stand up pouch of FIG. 7A taken along line B-B, in accordance with some embodiments discussed herein;

FIG. 7C illustrates a cross-sectional view of the example stand up pouch of FIG. 7A taken along line C-C, in accordance with some embodiments discussed herein;

FIG. 8A illustrates a top view of an example blank, in accordance with some embodiments discussed herein;

FIG. 8B illustrates a perspective view of an example package formed from the example blank of FIG. 8A, in accordance with some embodiments discussed herein; and

FIG. 8C illustrates a cross-sectional view of the end seal and triple point of the example package of FIG. 8B, in accordance with some embodiments discussed herein.

Repeated use of reference characters in the present specification and drawings is intended to represent the same or analogous features or elements of the present disclosure.

### DETAILED DISCLOSURE

Reference will now be made in detail to embodiments of the present disclosure, one or more examples of which are illustrated in the accompanying drawings. Each example is provided by way of explanation of the present disclosure, not limitation of the present disclosure. In fact, it will be apparent to those skilled in the art that modifications and variations can be made in the present disclosure without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents.

A recyclable paper-based packaging structure is described herein, but it should be understood that the invention herein could be utilized with a polymeric packaging structure or any other type of packaging structure known in the art. Paper-based packaging structures may, in particular, require a larger quantity of heat seal or adhesive material within the seams of the packaging structure to form and hold the packaging together in comparison to plastic packaging, which may be more inherently sealable. This may be particularly true in embodiments wherein no adhesive or heat seal material is present on the interior food-contact surface of the package. In some jurisdictions, in order to be recyclable at least 80% of the paper fibers, preferably 85% of the paper fibers and more preferably 90% of the paper fiber must be recovered. In this regard, the paper layer(s) of the present invention may account for the majority of the packaging structure by weight. Thus, the packaging structure may be formed of mostly paper and may comprise other layers which may provide barrier properties.

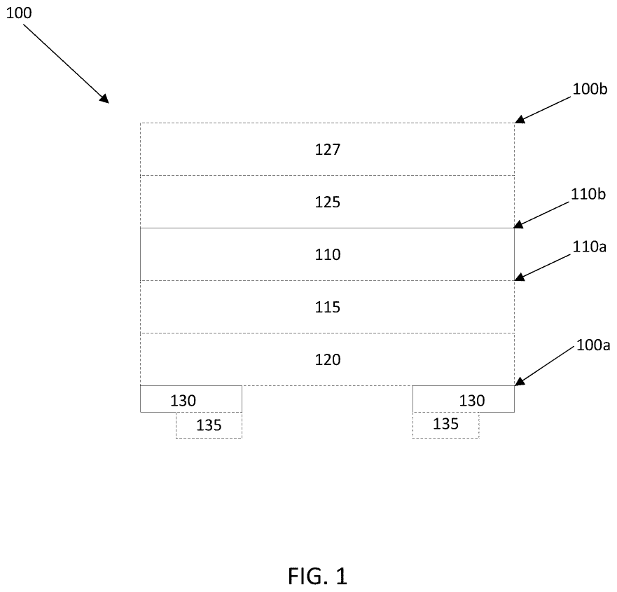

FIG. 1 illustrates an example packaging structure 100. In some embodiments, the packaging structure 100 may be a blank. In an embodiment, a paper layer 110 comprises the majority of the packaging structure 100, by weight (not illustrated to scale). The paper layer may account for up to 70% total weight of the packaging structure 100, or in another embodiment up to 80% total weight of the packaging structure 100, or in still another embodiment more than 90% of the total weight of the packaging structure 100. In some embodiments, the paper layer 110 may account for between 85-95% of the total weight of the packaging structure 100.

In some embodiments, the paper layer 110 may comprise only virgin paper, while in other embodiments, the paper layer 110 may comprise only recycled paper (post-consumer or post-industrial). In some embodiments, the paper layer 110 may comprise a mix of recycled paper and virgin paper.

The paper layer 110 may define a first surface 110a and a second surface 110b. In some embodiments, the first surface 110b may be interior facing and the second surface 110b may be exterior facing. In some embodiments, an ink layer 125 may be applied to the second surface 110b to indicate the product contained within the packaging structure 100. In some embodiments, the ink layer 125 may be printed by any known printing process.

In some embodiments, an overlacquer layer 127 may be applied over the ink layer 125. The overlacquer 127 may be a release layer such that a heat sealable adhesive or cold seal adhesive may be configured to release from the overlacquer rather than bonding thereto.

In some embodiments, an adhesive 115 may join the first surface 110a of the paper layer 110 to a barrier layer 120. In some embodiments, the adhesive 115 may be applied in a solid layer (e.g., flood coated) across the entirety of the first surface 110a of the paper layer 110, while in other embodiments, the adhesive 115 may be pattern applied, for example, a series of dots or concurrent parallel lines, or similar. The adhesive 115 may be configured as a buffer to coat the first side 110a of the paper layer without encapsulating the paper fibers forming the paper layer 110. In some embodiments, the adhesive 115 may be a water soluble adhesive. In this regard, when the packaging structure is exposed to the recycling process, the adhesive may dissolve and release the paper fibers from the barrier layer 120.

In some embodiments, the adhesive 115 may have a greater affinity for the barrier layer 120 than the paper layer 110. For example, the barrier layer 120 may be surface treated (e.g., corona flame treatment) which may retain the adhesive while the adhesive releases from the paper layer 110. In some embodiments, the adhesive 115 may be re-pulpable and/or releasable from the paper layer 110.

In some embodiments, the barrier layer 120 may be a polymeric film. In some embodiments, the barrier layer 120 may be a preformed sheet, web, or roll. In some embodiments, the barrier layer 120 may be HDPE, PE, PET, PP or other similar polymeric films. In some embodiments, the barrier layer 120 may be made from a single polymer, while in other embodiment the barrier layer 120 may be a blend of polymers or various layers of polymers. The barrier layer 120 may be chosen based on the desired properties for the final product. For example, a PE film may be used if the packaging will hold dry goods due to the moisture barrier properties, or a PET film may be used if the package will hold packaged goods, (e.g., meats or cheese due to the oxygen barrier properties).

In some embodiments, the barrier layer 120 may provide a barrier for migratory components between the product and the paper layer 100. In some embodiments, the barrier layer 120 may prevent any grease, mineral oil, or similar from transferring from the product to the paper layer 110, thereby preventing grease stains or creases within the paper layer.

In some embodiments, the packaging structure 100 may be used as a container for dry products including seasoning, mixes, cookies, crackers, nuts, animal food, animal snacks, animal treats, and the like. In some embodiments, the barrier layer may be the product facing side and the paper layer 110 may be the outer layer.

In some embodiments, the barrier layer 120 may be metalized to improve barrier properties. In some embodiments, the metalized layer will be de minimis, and able to be removed from the packaging structure with the barrier layer 120. As such the metallization should not contaminate the paper layer 110 upon repulping. In some embodiments, the barrier layer 120 may be metalized on the surface between the adhesive layer 115 and the barrier layer 120, while in other embodiments the barrier layer 120 may be metalized opposite the adhesive layer 115, optionally between the barrier layer 120 and an adhesive heat seal application.

In some embodiments, the barrier layer 120 may comprise any of various polymer-based materials including barrier polymer films such as ethylene vinyl alcohol copolymer (EVOH), polyamide and the like; metallized polyolefin films such as polyethylene, polypropylene, oriented polypropylene, and the like; AlOx-coated polymer films; SiOx-coated polymer films; metal foil such as aluminum foil; and others. In an embodiment, the barrier layer 120 may comprise metallized polyethylene terephthalate (PET), metallized oriented polypropylene (OPP), aluminum oxide (ALOX) PET, ALOX OPP, or silicon-oxide (SiOX) PET. In some embodiments, the barrier layer 114 may be a transparent film, thereby reducing the appearance of imperfections within the recycled paper fibers upon repulping. In some embodiments, the barrier layer 114 may be a metalized biaxially-oriented polyethylene terephthalate, for example, Mylar® manufactured by DuPont Teijin Films. In some embodiments, the metalized layer may be AlOx or another similar metal.

A first adhesive layer 130, which may be a heat sealable layer, may be applied to the first surface 110a of the paper layer 110, or the inner most structure, when other structures are present. The heat sealable adhesive may be pattern applied at locations of the seams of the packaging structure. In this regard, rather than including the heat sealable adhesive 130 across the entire structure, the heat sealable adhesive 130 is only present at the locations where a seam will be formed. The pattern application of the heat sealable adhesive 130 prevents the heat sealable adhesive 130 from contacting the contents of the package. Although described here as a heat sealable adhesive layer, any type of adhesive material may be used.

In some embodiments, a second adhesive 135 may be applied to the first adhesive layer 130. In an embodiment, the second adhesive 135 may be a cold seal, though any adhesive or heat sealable material known in the art could be utilized. The cold seal adhesive may be applied about the triple point (to be described herein), or the positions on the blank which will become the triple point, to form an improved seal at the seams of the packaging material.

### The Blank

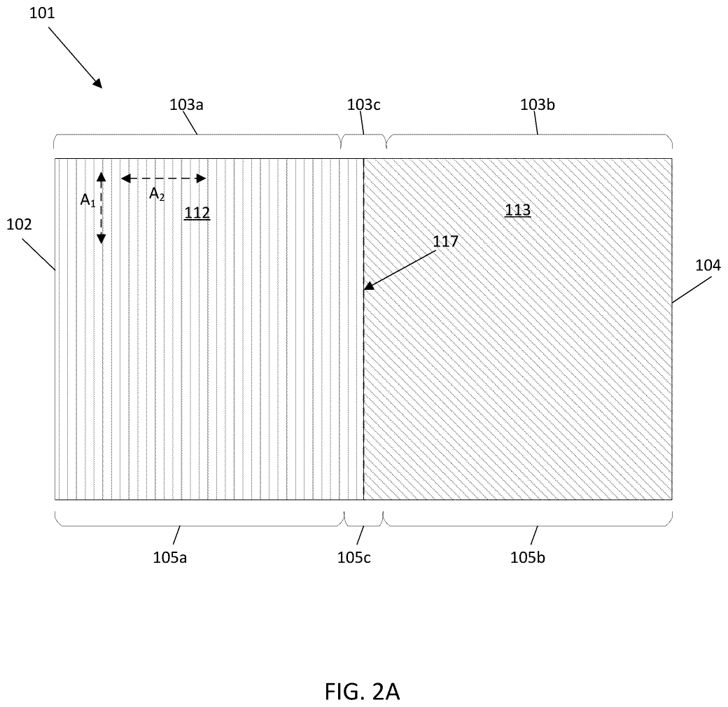

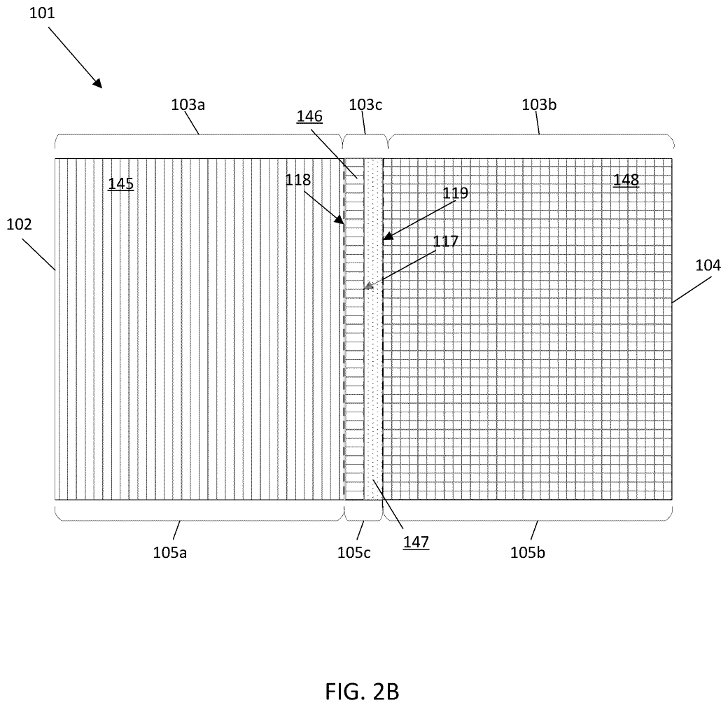

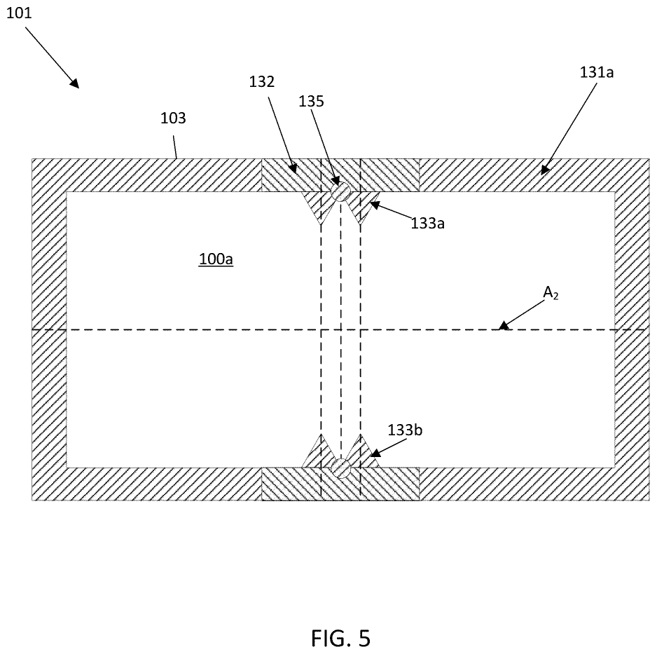

The packaging material 100 may be a blank 101. As illustrated in FIG. 2A-FIG. 5, the blank 101 may be formed from a continuous roll. The blank 101, in an embodiment, comprises a first edge 102, a second edge 103 a third edge 104 and a fourth edge 105, the edges 102-105 defining an outer periphery of the blank 101. In some embodiments, the fourth edge 105 may be parallel to the second edge 103, and the fourth edge 105 may be perpendicular to both the first edge 102 and the third edge 104.

In some embodiments, the blank 101 may define a longitudinal direction (A₁) and a transverse direction (A₂). The longitudinal direction may extend between the second edge 103 and the fourth edge 105 and may be perpendicular to the transverse direction, which may extend from the first edge 102 to the third edge 104.

In some embodiments, the blank 101 may be divided into a first half 112 and a second half 113 by a first fold line 117 in the center of the longitudinal direction of the blank 101. Each of the first half 112 and the second half 113 may be further divided by a second fold line 118 and a third fold line 119. In some embodiments, the second fold line 118 and the third fold line 119 may be evenly spaced from the first fold line 117, said differently the second fold lien 118 and the third fold line 119 may be symmetrical about the first fold line 117. In other embodiments the second fold line 118 and the third fold line 119 may not be symmetrical about the first fold line 117. The second fold line 118 and the third fold line 119 may be disposed near the first fold line 117, such that when the blank 101 is folded the second fold line 118 and the third fold line 119 may define the bottom or base of a package therebetween. In some embodiments, the second fold line 118 and the third fold line 119 may bound a gusset section extending between the center section 103c of the second edge 103 and the center section 105c of the fourth edge 105. In some embodiments, the gusset section may comprise sections 103c and 105c.

In some embodiments, the second fold line 118 may divide the first half 112 of the blank 101 into a first portion 145 and a second portion 146. Similarly, the third fold line 119 may divide the second half 113 of the blank 101 into a third portion 147 and a fourth portion 148. In this regard, the first portion 145 may be between the first edge 102 and the second fold line 118, and the first portion of the second edge 103a and the first portion of the fourth edge 105a. The second portion 146 may be between the second fold line 118 and the first fold line 117, and the center portion of the second edge 103c and the center portion of the fourth edge 105c. The third portion 147 may be between the first fold line 117 and the third fold line 119, and the center portion of the second edge 103c and the center portion of the fourth edge 105c. The fourth portion 148 may be between the third fold line 119 and the third edge 104 and the second portion of the second edge 103b and the second portion of the fourth edge 105b.

In some embodiments, the second edge 103 may define a plurality of sections, for example, a first section 103a, a second section 103b, and a center section 103c. In some embodiments, the first section 103a and the second section 103b may be on either edge of the center section 103c. Further, the first section 103a and the second section 103b may be evenly divided by the center section 103c. In this regard, the first section 103a and the second section 103b may be the same size, while the center section 103c may be smaller than each of the first section 103a and the second section 103b.

Similarly, in some embodiments, the fourth edge may define a plurality of sections, for example, a first section 105a, a second section 105b and a center section 105c. In some embodiments, each of the sections may be symmetrical with their counterpart, for example, the first section of the second edge 102a may be symmetrical with the first section of the fourth edge 105a, for example, over a center line extending in the transverse direction A₂ (e.g., between the first edge 102 and the third edge 104).

In some embodiments, the second portion 146 and the third portion 147 may form the gusset section 107. When folded into a packaging structure for example, a stand-up pouch, the gusset section 107 may form a bottom of the stand-up pouch, the first portion 145 may form a first wall of the stand-up pouch and the fourth portion 148 may form a second wall of the stand-up pouch as will be described further herein.

An adhesive layer (e.g., 130 FIG. 1) may be applied to the second surface 101b of the blank 101 to provide a sealable surface used for forming the blank 101 into a package as will be discussed herein. The adhesive layer may include one or more applications of an adhesive in the locations where a seam may be formed.

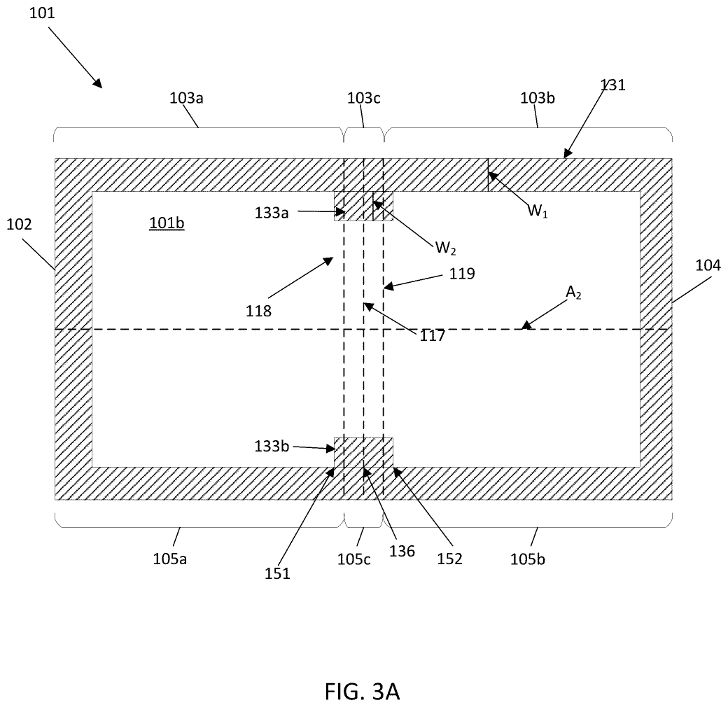

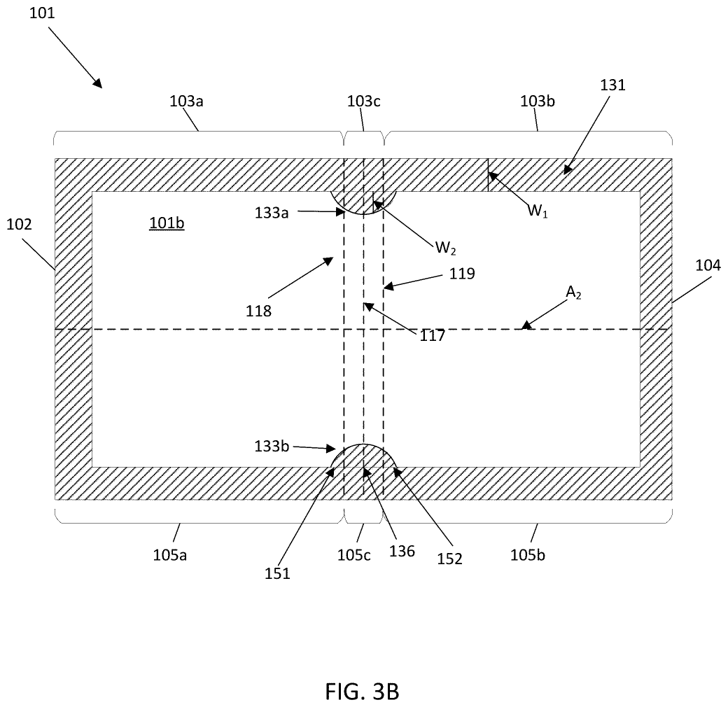

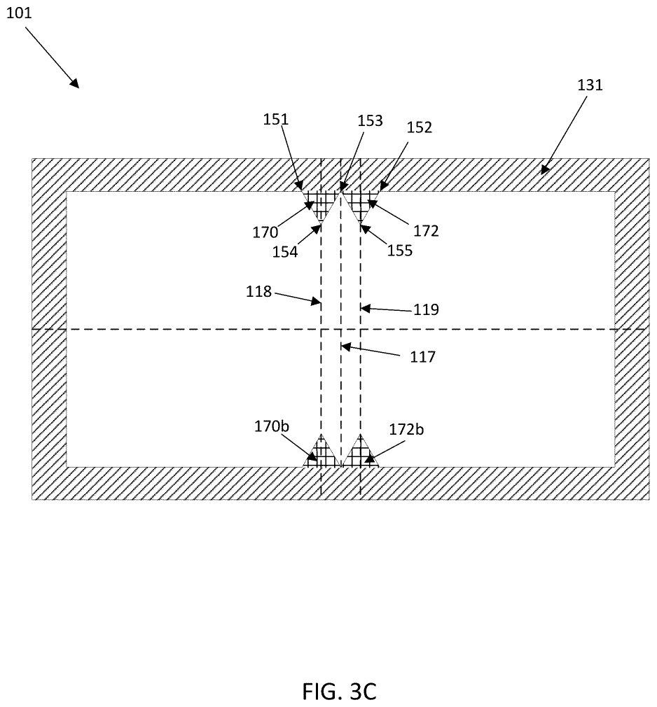

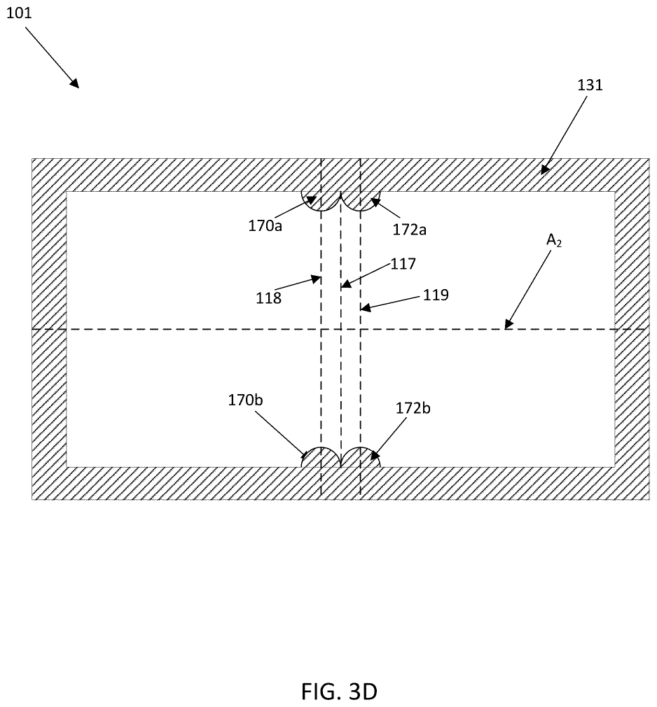

FIGS. 3A-D illustrate the application of a first adhesive layer 131 to the second surface of the blank 101 in a first pattern. In some embodiments, the first pattern may extend a first width W₁ about the perimeter of the blank 101 (e.g., along the first edge 102, the second edge 103, the third edge 104 and the fourth edge 105). The first pattern may further include a first extension 133a, and a second extension 133b which each extend beyond the first width W₁ towards the center of the blank (e.g., towards the transverse center line).

The first extension and the second extension 133a, 133b may be positioned on the second edge 103 and the fourth edge 105. More specifically, at least a portion of each of the first extension and the second extension 133a, 133b may be positioned within the gusset section 107 and may extend into each of the second edge 103 and the fourth edge 105. In some embodiments, the first extension and the second extension 133a, 133b may extend into the first portion 145 and the fourth portion 148 beyond the second fold line 118 and the third fold line 119.

In some embodiments, each of the first extension and the second extension 133a, 133b may each be symmetrical over at least the first fold line 117. Further, in some embodiments the first extension and the second extension 113a, 113b may be symmetrical across the transverse center line. In this regard, the first pattern may exhibit either one line of symmetry or two lines of symmetry (e.g., along the first fold line and/or along the transverse center line).

The first extension and the second extension 133a, 133b may define a second width W₂. In some embodiments, the second width W₂ may be measured from the first width W₂ while in other embodiments the second width W₂ may be measured from the edge of the blank (e.g., the second edge 103 or the fourth edge 105). In some embodiments, the second width W₂ may be constant, (see FIG. 3A), while in other embodiments, the second width W₂ may be variable (see FIG. 3B-D). In some embodiments, the first extension and the second extension 133a, 133b may be a rectangle, square, semi-circle, triangle, or other similar shape.

In some embodiments, the first extension and the second extension 133a, 133b may each comprise a single peak width, as illustrated in FIGS. 3A-B. In this regard, the extension may extend from a first minimum width at a first point 151 on the perimeter, extend to a maximum width at a third point 153, and return to second minimum width at a second point 152 on the perimeter. In some embodiments, the third point 153 at the maximum width may be along the first fold line 117, such as to maintain the symmetry of the extension.

In other embodiments the first extension and the second extension 133a, 133b may each comprise more than one peak width, as illustrated in FIGS. 3C-D. In this regard, the extension may extend from a first local minimum width at a first point 151 on the perimeter, extend to a first maximum width at a fourth point 154, return to a second local minimum width at a third point 153, extend to a second maximum width at a fifth point 155, and return to a third local minimum at the second point 152. In some embodiments, the fourth point 154 (e.g., first maximum width) may be along the second fold line 118 and the fifth point 155 (e.g., second maximum width) may be along the third fold line 118. The first point 151 (e.g., the first local minimum) may be within the first portion of the blank, and the second point 152 (e.g., the third local minimum) may be within the fourth portion of the blank, and the third point 153 (e.g., the second local minimum) may be along the third fold line 119.

In some embodiments, a first area 170 may be formed between the first point 151, the fourth point 154, and the third point 153, and a second area 172 may be formed between the third point 153, the fifth point 155, and the second point 152. In this regard, each of the first extension and the second extension 133a, 133b, may comprise a first area 170a, 170b, and a second area 172a, 172b.

In some embodiments, a second adhesive layer 132 may be applied to the first surface of the blank 101 in a second pattern. The second pattern may include portions of the blank 101 which will be joined together in a triple point when the blank is assembled into a stand-up pouch. As will be described herein a triple point is a point where at least three surfaces of the blank (e.g., the first point 151, the third point 153, and the second point 152) are heat sealed, heat welded or joined by the adhesive in the gusset seam area. Due to the joining of three surfaces the triple point(s) of packages have been a point of weakness where channels or leaks may develop between the surfaces joined at the triple point.

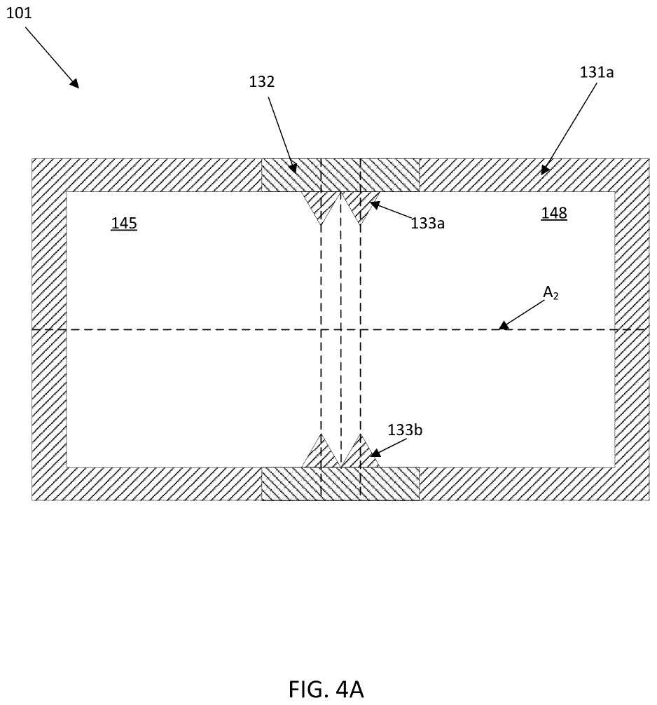

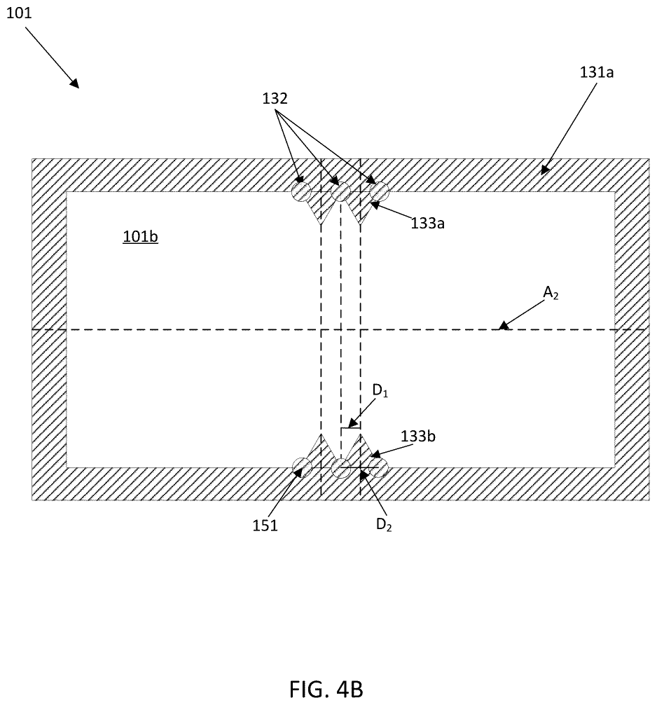

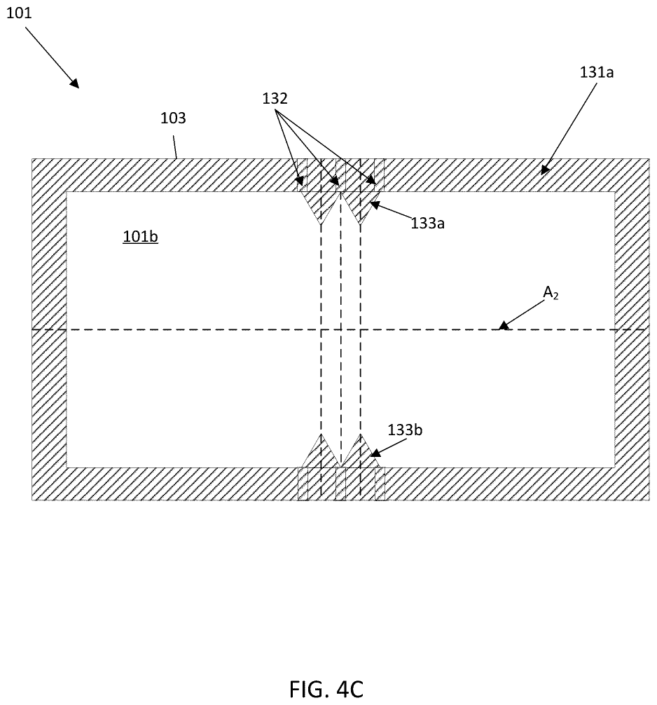

In some embodiments, illustrated in FIG. 4A, the second adhesive layer 132 may be positioned at least partially over the first adhesive layer 131. The second adhesive layer 132 may extend within the center section 103c, 105c of each respective side edge or perimeter/periphery, and into the first section 103a, 105a (e.g., longitudinally adjacent the center section) and the second section 103b, 103b (e.g., longitudinally adjacent the center section, opposite the first section) along each of the second edge 103 and the fourth edge 105 of the blank 101.

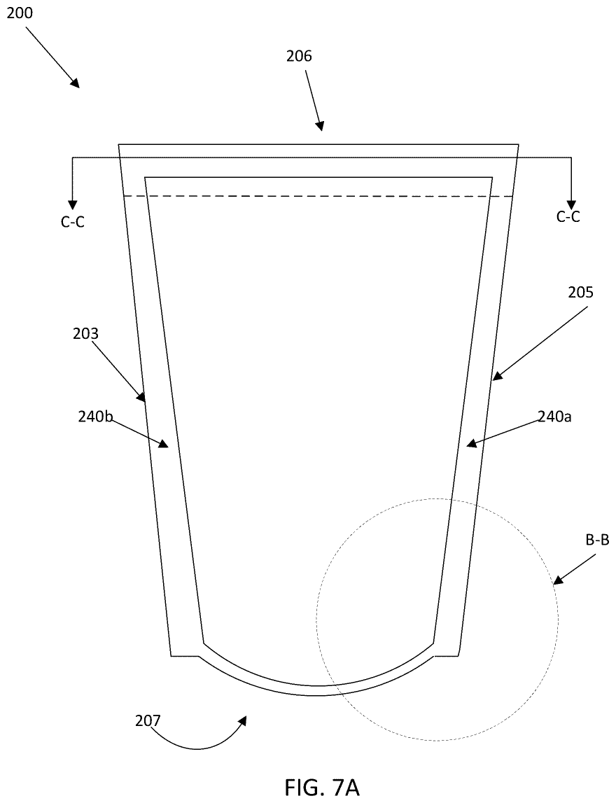

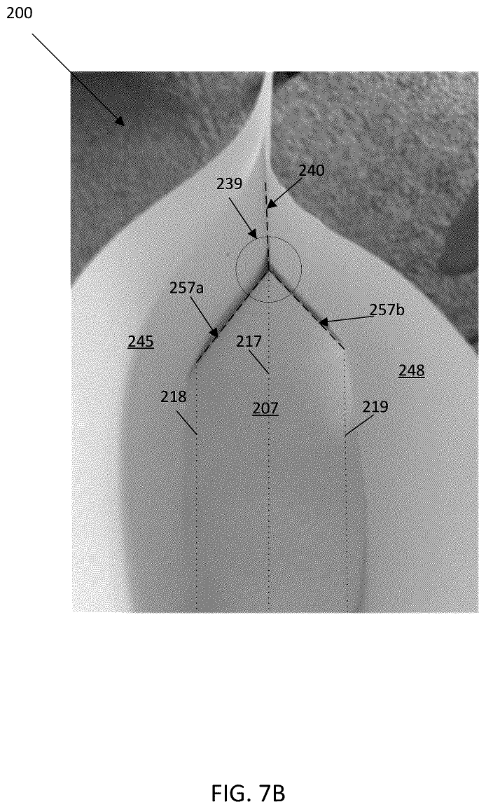

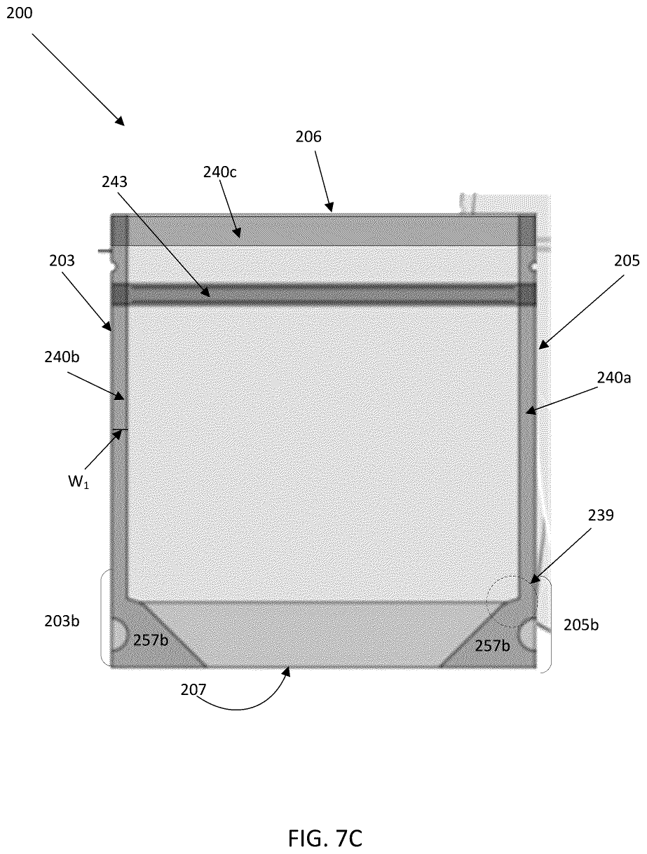

As illustrated in FIG. 4B, the second adhesive layer 132 may be positioned in the areas which will become the triple point, thereby reinforcing the triple point. In this regard, the second adhesive layer 132 may be optionally disposed in an area surrounding the center fold line 117 (within the periphery of the blank) and may be disposed in areas transversely adjacent the center fold line 117, in each transverse direction. The distance from the center fold line 117 to either the second fold line 118 or the third fold line 119 is defined herein as a first distance, D₁ In an embodiment, D₁ is doubled (e.g., 2×D₁) to form a second distance, D₂. The second distance, D₂ is measured from the center fold line 117 in each transverse direction and those locations are the central locations for the disposition of the triple point second adhesive layer 132. In an embodiment, the second adhesive layer 132 may be disposed in an area surrounding each of the second distances D₂, within the peripheral area of the blank and optionally extending outward of the peripheral area of the blank. The second adhesive layer 132 may be disposed in an area surrounding each of the second distances D₂ any amount. The second adhesive layer may be shaped as patches of adhesive, circular, square, triangular, rectangular, or any other shape or irregular pattern known, which surround the second distances D₂. The second layer of adhesive 132 may be positioned at the points which become the interior triple point (see e.g., 239 FIG. 7C).

Similarly, in some embodiments, the second adhesive layer 132 may extend continuously between the second distance D₂ on one side of the center fold line 117 to the second the second distance D₂ on the opposite side of the center fold line, as well as in areas surrounding each second distance D₂. Optionally, the application of the second adhesive 132 may extend continuously within the first width W₁ as well. The reinforcement at the triple point provides a greater amount of adhesive within the triple point thereby allowing a stronger seal to be formed at the seam.

In some embodiments, to further reinforce the triple point a third adhesive layer 135 may be positioned over a portion of the first adhesive layer 131 and/or the second adhesive layer 132. The third adhesive layer 135 may be disposed in a position on or surrounding the center fold line 117, in an embodiment. The third adhesive layer 135 may be a cold seal adhesive, in some embodiments.

The pattern applications of the first adhesive layer 131, the second adhesive layer 132, and optionally the third adhesive layer 135 reduces the total amount of adhesive needed to form the blank into a package, as compared to flood coating. The reduction in adhesive, reduces costs and further improves the quality of the goods contained in the package. As discussed, some goods may be sensitive to solvents and other materials used in adhesives. Thus, if the adhesive is flood coated over the blank the goods may come into contact with the adhesive and become compromised. However, applying the adhesive only in the locations where a seam will be formed, reduces, and almost eliminates the adhesive which contacts the goods within the package.

### Assembling an Example Packaging Structure

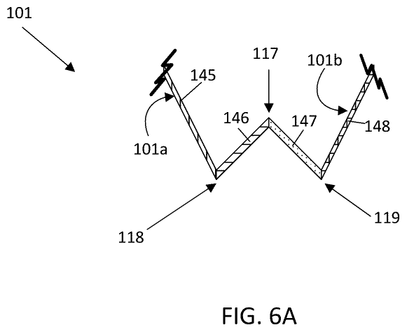

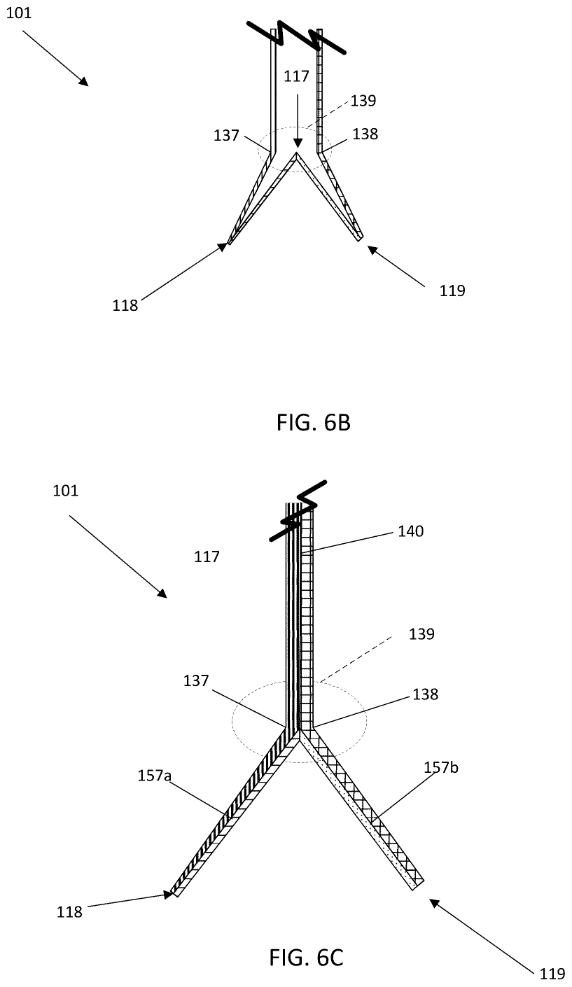

FIGS. 6A-C illustrate a side view of folding the blank to form a gusset and side seam of a stand-up package. The blank as described herein may be formed into a stand-up pouch or similar package. The stand-up pouch may be used to contain small piece goods (e.g., granola, pet treats, seeds, etc.), powders, granular products, as non-limiting examples.

To form the gusset and base of the pouch, the blank 101 may be folded at each of the first fold line 117 (disposed in the center of the longitudinal direction of the blank), the second fold line 118 and the third fold line 119, wherein each of the second fold line and the third fold line are equidistance from the first fold line, on opposite sides of the first fold line. The first fold line 117 may fold the blank in a first direction such that a first half of the first surface 110a (divided from a second half of the first surface 110a by the first fold line 117) is folded towards or against the second half of the first surface 110a. The second fold line 118 and the third fold line 119 may be configured to be folded in an opposite direction. To explain, the second fold line 118 may be configured to fold a first portion 145 (in some embodiments, the outermost portion with reference to the center fold line 117) of the second surface 101b toward or against a second portion 146 (in some embodiments, the portion adjacent the center fold line 117) of the second surface 101b, and the third fold line 119 may be configured to fold a third portion 147 (in some embodiments, the portion adjacent the center fold line 117) of the second surface 101b toward or against a fourth portion 148 (in some embodiments, the outermost portion with reference to the center fold line 117) of the second surface 101b. Thus, the blank, when viewed from the side or in cross-section, forms a “w” shape at this stage.

As illustrated in FIG. 6B, to form the gusseted bottom panel, the edges of the “w shape” may be brought together to form a triple point 139. When the first fold line, the second fold line, and the third fold line are folded, the triple point 139 may be formed between a first region 137, where the first portion 145 of the second surface 101b (or the first half of the second surface) contacts the first fold line 117, and a second region 138 where the fourth portion 148 of the second surface 101b (or the second half of the second surface) contacts the first fold line 117.

FIG. 6C illustrates a cross-section of the side/edge seam of the gusseted pouch. As illustrated in FIG. 6C a first seam 157a is formed between the first portion 145 of the second surface and the second portion 146 of the second surface, and a second seam 157b is formed between the third portion 147 of the second surface and the fourth portion 148 of the second surface. The first seam 157a and the second seam 157b may form a gusseted bottom of the stand-up pouch as will be discussed herein. A side seam 140 may be formed between the first portion 145 of the second surface 101b and the fourth portion 148 of the second surface 101b. A triple point 139 may be formed at the point between the side seam 140 and each of the first seam 157a and the second seam 157b. Thus, the triple point 139 is formed where two gusset seams (e.g., first seam 157a and second seam 157b) transition into the side seam 140.

As discussed, the triple point has traditionally been a point of weakness for the stand-up pouch. In the present invention, in order to reinforce the triple point 139, the second adhesive layer is utilized to increase the adhesive presence in the triple point 139 area, to ensure a strong juncture at the triple point, reduce the likelihood of failure, but not use an unnecessary amount of adhesive. In addition to providing a stronger seal at the triple point 139 junction, the reinforcement of the triple point 139 may seal any potential channels or leaks between the surfaces which are bonded by the triple point 139. Thus, as discussed, the second adhesive layer (e.g., 132) may be disposed, applied, or positioned on or between the first region 137 and the second region 138 thereby increasing the adhesive at those points. In some embodiments, the first region 137 may surround second distance D₂ on one side of the center fold line 117 and the second region 138 may surround second distance D₂ on the opposite side of the center fold line 117. Each of these points may comprise the second adhesive layer, thereby providing extra adhesive in and about the triple point 139, while reducing the overall amount of adhesive used in the formation of the stand-up pouch.

The heat seals may be formed by positioning the seam between heat seal jaws and forming seals between the adhesive layers positioned therebetween. The adhesive layers may be sealed between sealing jaws under pressure at relatively high temperatures in order to form the seals of the pouch. Appropriate sealing temperatures includer 140-150 degrees C. if the heat seal layers are CPP, and 135-145 degrees C. for cross-linked polyethylene. Sealing can be performed under pressure of about 275 kilopascals (about 40 pounds per square inch) using a dwell time of about 1 second. Higher temperatures may be used if shorter dwell times are desired.

### The Stand-Up Pouch

FIGS. 7A-C show a pouch 200 that can be made from the blank of the present invention. The pouch 200 may be a three-sided seal pouch with a top seal (or similar closure), a first side seam and a second side seam. Each of the first side seam and the second seam seal may include the gusset discussed herein with reference to FIG. 6C.

When the blank is folded into the pouch 200, the first edge (e.g., 102) and the third edge (e.g., 104) are sealed together and form a top end 206 of the stand-up pouch 200. Each of the second edge (e.g., 103) and the fourth edge (e.g., 105) are sealed against themselves. In this regard, the first section (e.g., 103a) is sealed to the second section (e.g., 103b) of the second edge, and similarly, the first section (e.g., 105a) is sealed to the second section (e.g., 105b) of the fourth edge, there by forming a second edge 203 and fourth edge 205 of the stand-up pouch 200. A bottom 207 of the stand-up pouch 200 is bounded by the second fold line 118, the third fold line 119. The bottom 207 of the stand-up pouch may comprise a gusset fold on each of the second edge 203 and the fourth edge 205. The gusset fold may expand to create a flat bottom 107 of the stand-up package when filled with goods. In contrast, when the stand-up pouch is empty the bottom may fold and return to the “W shape” as discussed.

The gusset as described may be formed at the transition between the bottom 207 and the second edge 203 and the bottom 207 and the fourth edge 205. FIG. 7B illustrates an inner section of the stand-up pouch 200 taken within area B-B of FIG. 7A.

The first portion (e.g., 145) of the blank becomes a first wall 245 of the stand-up pouch and the fourth portion (e.g., 148) of the blank becomes a second wall 248 of the stand-up pouch, while the gusset section (e.g., second portion 146 and third portion 147) become the bottom 207.

The gusset formed between the first wall 245, the bottom 207 and the second wall 248 allows the bottom 207 to expand to a flat surface, as illustrated, and contract to a flat fold (e.g., collapsing along the first fold line 217).

The first seam 257a may be formed between the first wall 245 and the bottom 207, while the second seam 257b may be formed between the second wall 248 and the bottom 207. The first seam 257a and the second seam 257b may combine into a side seam 240 at the triple point 239. As discussed earlier, more adhesive material may be present within the first seam 257a, the second seam 257b and at the triple point 239 as compared to the side seam 240. This is due to the need to have a stronger seal at the triple point 239, as triple points may be a point of weakness (e.g., where a channel or leak may be formed) within the packaging structure. In some embodiments, the triple point 239 may extend throughout the width of the seam.

To explain further, FIG. 7C illustrates a cross-sectional view of the stand-up pouch 200. In some embodiments, each of the side seams 240a, 240b may extend a first width W₁ towards the center of the stand-up pouch 200. The first width W₁ is the width of the first adhesive layer applied to the blank.

In some embodiments, in addition to a top seam 240c adjacent the top edge 206, a reclosable feature 243 may be positioned in the stand-up pouch. In some embodiments, the reclosable feature 243 may be a resealable adhesive, a hook and loop fastener, a zip track closure, slider closure or similar.

Thus, the pattern application of the heat sealable adhesive and, optionally, the cold seal adhesive present only, or primarily, within the locations of seams formed in the packaging structure reduces the amount of adhesive used within the package, thereby providing a recyclable structure which provides proper barrier properties and does not alter or contaminate the goods within the packaging structure.

### Additional Packaging Structures

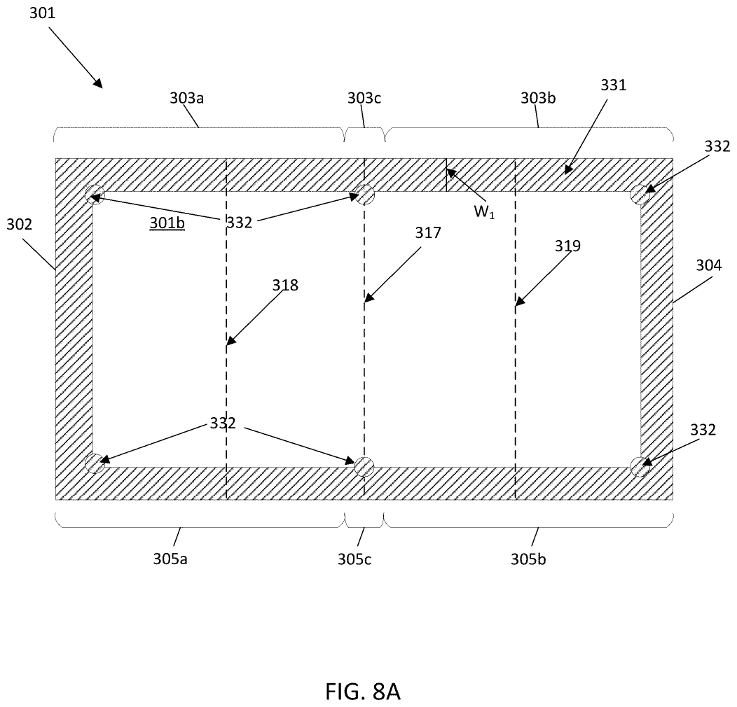

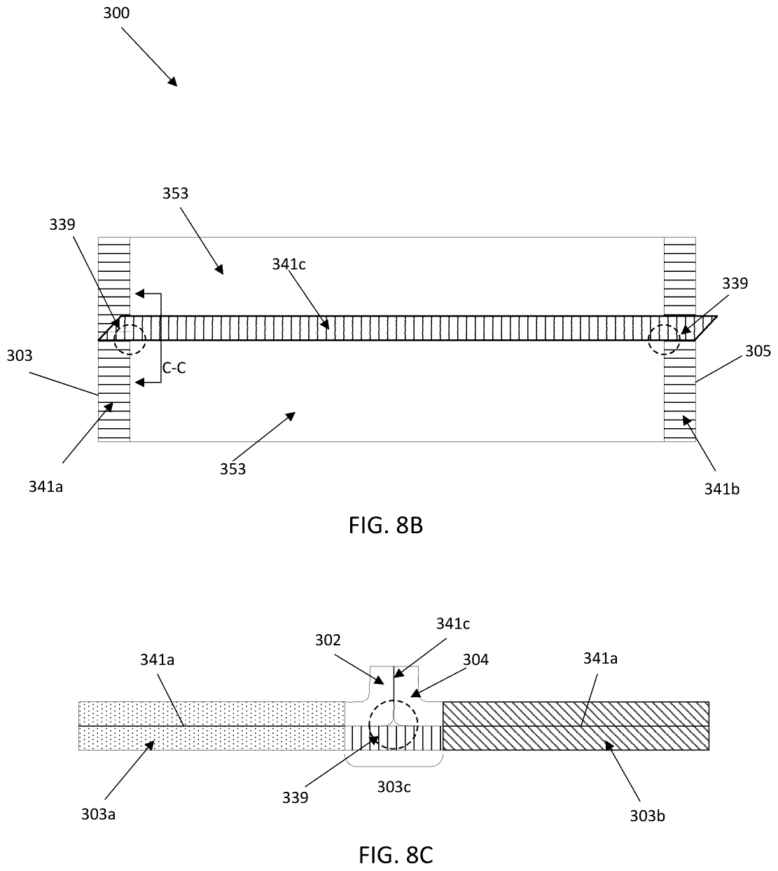

FIGS. 8A-C illustrate another example blank and packaging structure of the present invention. As discussed with reference to stand-up pouches, and packaging with gusset seals, many other packaging structures comprise triple points, as such other packages may benefit from additional sealing at the triple point to prevent the development of any channels or leaks between the joined surfaces.

FIG. 8A illustrates an example blank 301 which folds into a flow wrap package 300. As discussed with reference to FIGS. 2A-5, the blank 301 may be a continuous material defining a first edge 302, a second edge 303, a third edge 304 and a fourth edge 305. Further, the second edge, and the fourth edge may each define a plurality of sections, for example a first section 303a, 305a a, a second section 303b, 305b, and a center section 303c, 305c, where each corresponding section is symmetrical.

In some embodiments, an adhesive layer 331 may be applied to a second surface 301b of the blank 301 in a first pattern. In some embodiments, the first pattern may extend a first width W₁ about the perimeter of the blank 301 (e.g., the first edge 302, the second edge 303, the third edge 304, and the fourth edge 305). In some embodiments, the first adhesive layer 331 may take the shape illustrated in any of FIGS. 2A-5.

In some embodiments, a second adhesive layer 332 may be positioned at least partially on the second surface 301b of the blank 301, and at least partially on the first adhesive layer 331. In some embodiments, the second adhesive layer 332 may be positioned entirely on the first adhesive layer 331, while in other embodiments the second adhesive layer 332 may be positioned entirely on the second surface of the blank 301b.

In some embodiments, the second adhesive layer 332 may be positioned in the areas which will become the triple point. With reference to FIGS. 8B-C, the blank 301 may be folded and sealed into an example package 300. The package 300 is formed as a hollow tube with sealed ends 341a, 341b and having a generally rectangular construction. The package 300 comprises a generally elongated body 353 with two end seals 341a, 341b, and a lap seal 341c extending therebetween.

The package 300 is formed by folding the blank 301 along the second fold line 118 and the third fold line 319 and sealing the respective portions of the edges. In some embodiments, the first end seal 341a is formed from folding the blank over the second fold line 318 and the third fold line 219 and creating a seal between the overlapping first sections 303a of the second side, and between the overlapping second sections 303b of the second side. Similarly, the second end seal 341b is formed when the blank 301 is folded over the second fold line 318 and the third fold line 319 and a seal is formed between the overlapping first sections 305a and between the overlapping second sections 305b. The lap seal 341c may be formed between the first edge 302 and the fourth edge 304 of the blank 301.

The package 300 may comprise two triple points 339. Each of the triple points 339 may be formed between the first edge 302, the third edge 304, and one of the center portions 303c, 305c, of either the second edge or the fourth edge. In some embodiments, the first end seal 341a and the second end seal 341b may extend into the triple point 339.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A blank comprising:
a paper layer defining a first surface and a second surface opposite the first surface, and a longitudinal direction;
a first fold line disposed in the center of the longitudinal direction of the blank, forming a first half and a second half of each of the first surface and the second surface, wherein the first fold line is configured to fold the first half of the first surface toward the second half of the first surface;
a second fold line and a third fold line, wherein each of the second fold line and the third fold line are equidistance from the first fold line, on opposite sides of the first fold line, wherein the second fold line is configured to fold a first portion of the second surface toward a second portion of the second surface, and wherein the third fold line is configured to fold a third portion of the second surface toward a fourth portion of the second surface,
wherein when the first fold line, the second fold line, and the third fold line are folded, a triple point is formed between a first region where the first half of the second surface contacts the first fold line and a second region where the second half of the second surface contacts the first fold line;
a first adhesive layer applied in a first pattern to the second surface, wherein the first pattern defines a first width about a perimeter of the second surface, and wherein the first pattern further includes a first extension and a second extension each defining a second width, wherein the second width extends beyond the first width towards a center of the blank; and
a second adhesive layer, wherein the second adhesive layer is disposed at least partially within the triple point.

2. The blank of claim 1, wherein the first extension and the second extension extend transversely from the from the first fold line toward and across the second and third fold lines, respectively, to an end point disposed at a distance which is double the distance from the first fold line to the second or third fold line, respectively.

3. The blank of claim 2, wherein the second width increases between the first fold line and the end point of the first extension and the second extension, respectively.

4. The blank of claim 2, wherein the second width of the first extension and the second extension reach a local maximum at a point on the second fold line and a point on the third fold line.

5. The blank of claim 2, wherein the second width of the first extension and the second extension reach a local minimum at the center line and at the end point of the first extension and the second extension, respectively.

6. The blank of claim 1, wherein the second adhesive layer is disposed at least partially within the first width, surrounding a first point which is located a distance which is double the distance from the first fold line to the second fold line and a second point which is located a second distance which is double the distance from the first fold line to the third fold line.

7. The blank of claim 6, wherein the first point and the second point are equidistance from the first fold line.

8. The blank of claim 6, wherein the second adhesive layer extends beyond the first width, toward the center of the blank.

9. The blank of claim 1, wherein the first adhesive layer comprises a heat sealable material.

10. The blank of claim 1, wherein the first adhesive layer and the second adhesive layer comprise the same adhesive.

11. The blank of claim 1, further comprising a third adhesive layer, wherein the third adhesive layer is positioned at least surrounding the first fold line, at least within the first width.

12. The blank of claim 11, wherein the third adhesive layer comprises a cold seal adhesive.

13. A method of making a blank, the method comprising:
providing a paper layer defining a first surface, a second surface and a longitudinal direction, wherein the paper layer defines a first fold line disposed in the center of the longitudinal direction of the paper layer, wherein the first fold line is configured to fold a first half of the first surface toward a second half of the first surface;
a second fold line and a third fold line, wherein each of the second fold line and the third fold line are equidistance from the first fold line, on opposite sides of the first fold line, wherein the second fold line is configured to fold a first portion of the second surface toward a second portion of the surface, and wherein the third fold line is configured to fold a third portion of the second surface toward a fourth portion of the second surface,
wherein when the first fold line, the second fold line, and the third fold line are folded, a triple point is formed between a first region where the first half of the second surface contacts the first fold line and a second region where the second half of the second surface contact the first fold line;
applying a first adhesive layer to the second surface of the paper layer in a first pattern, wherein the first pattern defines a first width about a perimeter of the second surface and wherein the first pattern further includes a first extension and a second extension each defining a second width, wherein the second width extends beyond the first width towards a center of the blank; and
applying a second adhesive layer to the second surface, wherein the second adhesive layer is disposed at least partially within the triple point.

14. The method of claim 13 further comprising applying a third adhesive layer at least partially surrounding the first fold line, at least partially within the first width.

15. The method of claim 13, wherein the third adhesive layer comprises a cold seal adhesive.

16. The method of claim 13, wherein the first adhesive layer and the second adhesive layer comprise a heat sealable adhesive.

17. The method of claim 13, wherein the first extension and the second extension extend transversely from the first fold line towards and across the second and third fold lines, respectively, to an end point disposed at a distance which is double the distance from the first fold line to the second or third fold line respectively.

18. The method of claim 17, wherein the second width increases between the first fold line and the end point of the first extension and the second extension, respectively.

19. A packaging structure formed from the blank of claim 1.

20. A stand-up pouch comprising:
a front wall joined to a rear wall along a top seam, a first side seam, and a second side seam;
a gusset panel joining the front wall to the rear wall to form a stand-up base of the pouch, wherein the gusset panel is continuous with the front wall and the rear wall, the gusset panel comprising a first triple point disposed within the juncture of the base and the first side seam and a second triple point within the juncture of the base and the second side seam;
a first adhesive layer, wherein the first adhesive layer is applied within each of the first side seam, the second side seam, and the top seam; and
a second adhesive layer, wherein the second adhesive layer is applied within the first triple point and the second triple point.

21. The stand-up pouch of claim 20, further comprising a third adhesive layer positioned about the first triple point and the second triple point, wherein the third adhesive layer comprises a different adhesive than the first adhesive layer and the second adhesive layer.

22. A blank comprising:
a paper layer defining a first surface and a second surface opposite the first surface, and a longitudinal direction;
a first fold line disposed in the center of the longitudinal direction of the blank, forming a first half and a second half of each of the first surface and the second surface, wherein the first fold line is configured to fold the first half of the first surface toward the second half of the first surface;
a second fold line and a third fold line, wherein each of the second fold line and the third fold line are equidistance from the first fold line, on opposite sides of the first fold line, wherein the second fold line is configured to fold a first portion of the second surface toward a second portion of the second surface, and wherein the third fold line is configured to fold a third portion of the second surface toward a fourth portion of the second surface,
wherein when the second fold line, and the third fold line are folded towards the first fold line, a triple point is formed between a first region where the first half of the second surface contacts the first fold line and a second region where the second half of the second surface contacts the first fold line;
a first adhesive layer applied in a first pattern to the second surface, wherein the first pattern defines a first width about a perimeter of the second surface; and
a second adhesive layer, wherein the second adhesive layer is disposed at least partially within the triple point.

23. A recyclable package comprising:
a recyclable sheet joined along a first end seal, a second end seal, and a lap seal extending between the first end seal and the second end seal,
wherein a first triple point is formed at a juncture of the first end seal and the lap seal, and a second triple point is formed at a juncture of the second end seal and the lap seal;
a first adhesive layer, wherein the first adhesive layer is applied within each of the first end seal, the second end seal and the lap seal; and
a second adhesive layer, wherein the second adhesive layer is applied within the first triple point and the second triple point.
